(19) United States
(12) Patent Application Publication
(10) Pub. No.: US 2013/0093865 A1
(43) Pub. Date: Apr. 18, 2013

(54) MODULE AND METHOD FOR RECOGNIZING INTENDED TARGET OF UNIVERSAL REMOTE CONTROLLER

(71) Applicants: KUO-CHAN PENG, PINGZHEN CITY (TW); CHING-FENG HSIEH, TAIPEI CITY (TW)

(72) Inventors: KUO-CHAN PENG, PINGZHEN CITY (TW); CHING-FENG HSIEH, TAIPEI CITY (TW)

(73) Assignees: ASKEY COMPUTER CORP.; ASKEY TECHNOLOGY (JIANGSU) LTD.

(21) Appl. No.: 13/297,564

(22) Filed: Nov. 16, 2011

(30) Foreign Application Priority Data
Oct. 18, 2011 (TW) 100137684

(51) Int. Cl. H04N 7/18

(52) U.S. Cl. 348/61; 348/E07.085

(57) ABSTRACT

A module and method for recognizing an intended target of a universal remote controller are provided and are applicable to a universal remote controller and at least one intended target. The universal remote controller has a manipulating device and a protocol unit. The module comprises a processing unit, a storing unit, and an image sensing unit for capturing an intended image to be treated as a subject image data. The processing unit compares an image data stored and related to the at least one intended target with the subject image data to determine the recognized intended target, and defines a manipulating function of the manipulating device based on a manipulating data attributed to the recognized intended target such that the universal remote controller remotely controls the recognized intended target in accordance with manipulation of the manipulating device and by the protocol unit.

### CROSS-REFERENCE TO RELATED APPLICATION

This non-provisional application claims priority under 35 U.S.C. §119(a) on Patent Application No(s).100137684 filed in Taiwan, R.O.C. on Oct. 18, 2011, the entire contents of which are hereby incorporated by reference.

### FIELD OF TECHNOLOGY

The present invention relates to recognition modules and recognition methods, and more particularly, to a module and method for recognizing an intended target of a universal remote controller.

### BACKGROUND

Due to the convenience brought by remote control technology, electric appliances nowadays rely increasingly upon remote controllers in order to be capable of being remotely controlled. Users in possession of remote controllers increase with the electric appliances capable of being remotely controlled. However, a plethora of remote controllers poses management issues inevitably.

Hence, a universal remote controller was designed to function as a single remote controller for replacing multiple remote controllers operating together, and was aimed at streamlining management and usage of the conventional universal remote controller. However, operation of the conventional universal remote controller necessitates a matching process. The purpose of the match process is to set a remote control target (i.e. an intended electric appliance) of the conventional universal remote controller. A user has to select the remote control target manually, using a key or touchscreen on the conventional universal remote controller. The manual selection process is not user-friendly. For example, elderly users find it difficult to recognize a remote control target of the conventional universal remote controller.

### SUMMARY

It is an objective of the present invention to provide a module for recognizing an intended target of a universal remote controller automatically.

In order to achieve the above and other objectives, the present invention provides a module for recognizing an intended target of a universal remote controller. The module is applicable to a universal remote controller and at least one intended target. The universal remote controller has a manipulating device and a protocol unit. The module comprises: a storing unit for storing an image data related to the at least one intended target and a manipulating data attributed to the at least one intended target; an image sensing unit for capturing an intended image to be treated as a subject image data; and a processing unit connected to the storing unit, the image sensing unit, the manipulating device, and the protocol unit for comparing image data stored in the storing unit and attributed to at least one intended target with the subject image data to determine the recognized intended target, and defining a manipulating function of the manipulating device based on a manipulating data attributed to the recognized intended target such that the universal remote controller remotely controls the recognized intended target in accordance with manipulation of the manipulating device and by the protocol unit.

In an embodiment, the image sensing unit is a charge-coupled device (CCD) or a complementary metal-oxide-semiconductor (CMOS).

In an embodiment, the image sensing unit and the protocol unit are disposed on a lateral side of the universal remote controller in a manner that the image sensing unit and the protocol unit face the same direction.

The present invention further provides a method for recognizing an intended target of a universal remote controller. The method is applicable to a universal remote controller and at least one intended target. The universal remote controller has a manipulating device and a protocol unit for remotely controlling the at least one intended target recognized. The method comprising the steps of: storing an image data related to the at least one intended target and a manipulating data attributed to the at least one intended target; capturing an intended image to be treated as a subject image data; comparing the image data related to the at least one intended target with the subject image data to determine the recognized intended target; and defining a manipulating function of the manipulating device based on the manipulating data attributed to the recognized intended target such that the universal remote controller remotely controls the recognized intended target in accordance with manipulation of the manipulating device and by the protocol unit.

Accordingly, the present invention discloses capturing an intended image, recognizing an intended target, and switching to a manipulating function of a remote controller automatically to thereby enhance the ease of selecting a recognized intended target such that users only need to capture an image attributed to intended targets, thereby enhancing ease of use greatly.

### BRIEF DESCRIPTION OF THE DRAWINGS

Objectives, features, and advantages of the present invention are hereunder illustrated with specific embodiments in conjunction with the accompanying drawings, in which:

FIG. 1 is a functional block diagram of a module for recognizing an intended target of a universal remote controller in an embodiment of the present invention;

FIG. 2 is a perspective view of the universal remote controller in an embodiment of the present invention; and

FIG. 3 is a flow chart of a method for recognizing an intended target of a universal remote controller in an embodiment of the present invention.

### DETAILED DESCRIPTION

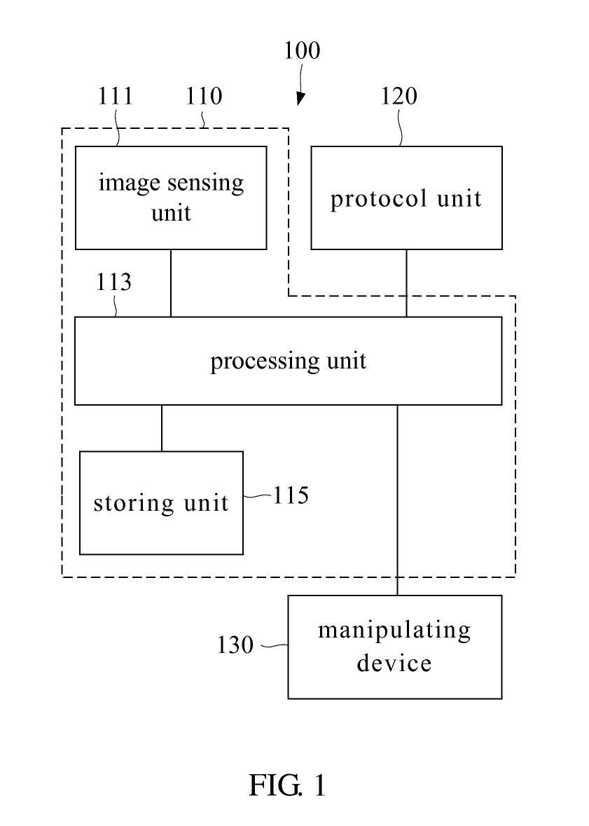

Referring to FIG. 1, there is shown a functional block diagram of a module 110 for recognizing an intended target of a universal remote controller in an embodiment of the present invention. The module 110 provides a universal remote controller 100 with a data related to an intended target (exemplified by a TV set or an air conditioner but not shown.) The module 110 recognizes the intended target automatically. Then, the intended target thus recognized is manipulated by a built-in manipulating device 130 of the universal remote controller 100. Eventually, the intended target is remotely controlled by a built-in protocol unit 120 of the universal remote controller 100.

The manipulating device 130 functions as a control interface operable by key or by touch. The universal remote controller 100 enables a control key thereon or control block (when the universal remote controller 100 operates like a touch-control device) thereon available to the intended target according to the recognized intended target. The protocol unit 120 is provided in the form of any infrared emission unit in general; alternatively, a Bluetooth emission unit or any appropriate radio emission unit is applicable to the present invention.

Referring to FIG. 1, in an embodiment of the present invention, the module 110 comprises a storing unit 115, an image sensing unit 111, and a processing unit 113.

The storing unit 115 stores an image data related to the intended target and a manipulating data attributed to the intended target. In practice, a user performs a matching process in advance, which involves storing an image data related to an electric appliance and storing a manipulating data attributed to the electric appliance. Alternatively, the user downloads from a website of the manufacturer of the module 110 an image data and manipulating data attributed to various electric appliances and stores the image data and manipulating data in the storing unit 115.

The image sensing unit 111 captures an intended image which is not only attributed to the intended target but is also to be treated as a subject image data.

The processing unit 113 is connected to the storing unit 115, the image sensing unit 111, the manipulating device 130, and the protocol unit 120. The processing unit 113 compares image data stored in the storing unit 115 and attributed to various electric appliances with the subject image data to select the recognized intended target from the electric appliances. Furthermore, the processing unit 113 defines a manipulating function of the manipulating device 130 based on the manipulating data stored in the storing unit 115 and attributed to the recognized intended target. Furthermore, the processing unit 113 enables, according to the recognized intended target, a control key thereon or control block (when the universal remote controller 100 operates like a touch-control device) thereon available to the recognized intended target. When operable by touch, the manipulating device 130 receives a manipulating data sent from the processing unit 113 and attributed to the recognized intended target, and then its touchscreen changes to suit controllable functions of the recognized intended target. When operable by key, the manipulating device 130 receives a manipulating data sent from the processing unit 113 and attributed to the recognized intended target, and only a key corresponding to a controllable function of the recognized intended target is available to the user, but the other keys are unavailable even when pressed.

The image sensing unit 111 shown in FIG. 1 is a charge-coupled device (CCD), a complementary metal-oxide-semiconductor (CMOS), or the like. The universal remote controller 100 can also be provided in the form of a smartphone.

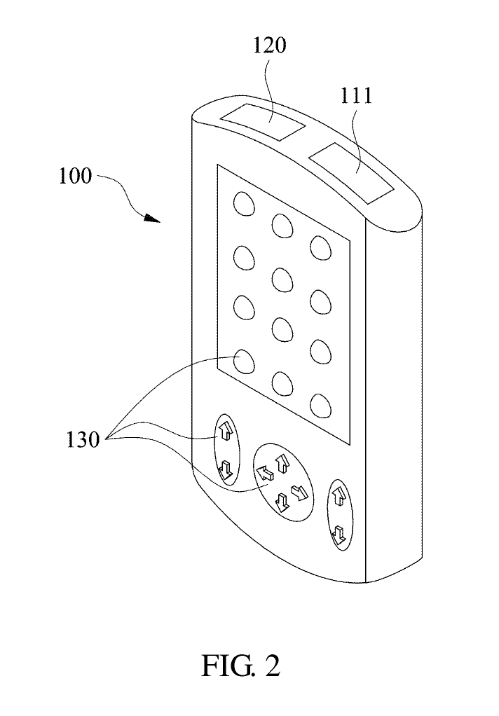

Referring to FIG. 2, there is shown a perspective view of the universal remote controller in an embodiment of the present invention. In a preferred embodiment, the image sensing unit 111 and the protocol unit 120 are disposed on a lateral side of the universal remote controller 100 in a manner that the image sensing unit 111 and the protocol unit 120 face the same direction. Hence, the user can point the universal remote controller 100 at the intended target and capture images (by key or by any appropriate means) conveniently without the hassles of turning over the universal remote controller 100.

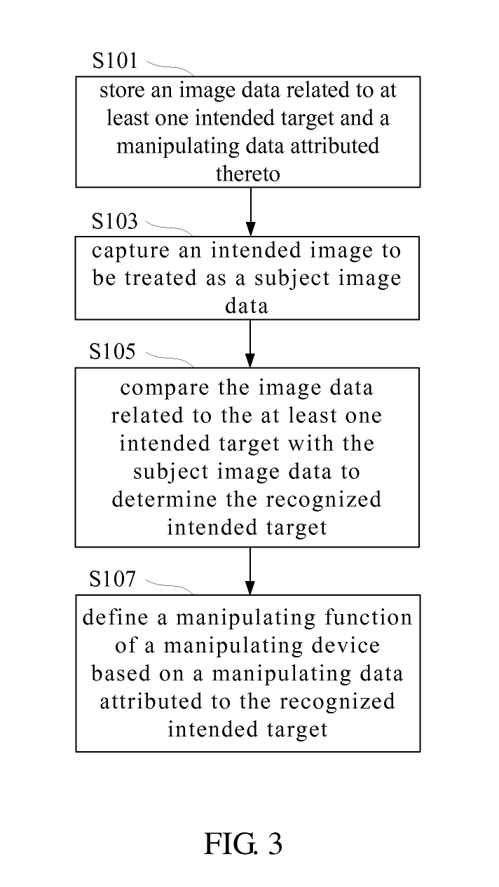

Referring to FIG. 3, there is shown a flow chart of a method for recognizing an intended target of a universal remote controller in an embodiment of the present invention. The method comprises the steps of:

S101: storing an image data related to at least one intended target and a manipulating data attributed to the intended target;

S103: capturing an intended image to be treated as a subject image data;

S105: comparing the image data related to the at least one intended target with the subject image data to determine the recognized intended target; and

S107: defining a manipulating function of a manipulating device based on the manipulating data attributed to the recognized intended target such that the universal remote controller remotely controls the recognized intended target in accordance with manipulation of the manipulating device and by the protocol unit.

In conclusion, a module and method for recognizing an intended target of a universal remote controller according to the present invention features automatic recognition that greatly enhances the ease of selecting a recognized intended target such that the user only needs to capture an image attributed to intended targets, thereby enhancing ease of use greatly.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A module for recognizing an intended target of a universal remote controller, applicable to a universal remote controller and at least one intended target, the universal remote controller having a manipulating device and a protocol unit, the module comprising:
a storing unit for storing an image data related to the at least one intended target and a manipulating data attributed to the at least one intended target;
an image sensing unit for capturing an intended image to be treated as a subject image data; and
a processing unit connected to the storing unit, the image sensing unit, the manipulating device, and the protocol unit for comparing image data stored in the storing unit and attributed to the at least one intended target with the subject image data to determine the recognized intended target, and defining a manipulating function of the manipulating device based on the manipulating data attributed to the recognized intended target such that the universal remote controller remotely controls the recognized intended target in accordance with manipulation of the manipulating device and by the protocol unit.

2. The module of claim 1, wherein the image sensing unit is one of a charge-coupled device (CCD) and a complementary metal-oxide-semiconductor (CMOS).

3. The module of claim 1, wherein the image sensing unit and the protocol unit are disposed on a lateral side of the universal remote controller in a manner that the image sensing unit and the protocol unit face a same direction.

4. The module of claim 2, wherein the image sensing unit and the protocol unit are disposed on a lateral side of the universal remote controller in a manner that the image sensing unit and the protocol unit face a same direction.

5. A method for recognizing an intended target of a universal remote controller, applicable to a universal remote controller and at least one intended target, the universal remote controller having a manipulating device and a protocol unit for remotely controlling the at least one intended target recognized, the method comprising the steps of:
storing an image data related to the at least one intended target and a manipulating data attributed to the at least one intended target;
capturing an intended image to be treated as a subject image data;
comparing the image data related to the at least one intended target with the subject image data to determine the recognized intended target; and
defining a manipulating function of the manipulating device based on the manipulating data attributed to the recognized intended target such that the universal remote controller remotely controls the recognized intended target in accordance with manipulation of the manipulating device and by the protocol unit.
